(19) United States
(12) Patent Application Publication
(10) Pub. No.: US 2026/0242192 A1
(43) Pub. Date: Aug. 20, 2026

(54) BENDING-ARTICULATED UNMANNED ROBOTIC FORKLIFT SYSTEM AND AUTONOMOUS TRAVELING METHOD USING SAME

(71) Applicant: ROGISTICS CORP., Gyeongsan-si, Gyeongsangbuk-do (KR)

(72) Inventors: Nak Eun CHOI, Busan (KR); Dae Hoon PARK, Busan (KR); Sang Gil PARK, Hwaseong-si, Gyeonggi-do (KR)

(73) Assignee: ROGISTICS CORP., Gyeongsan-si, Gyeongsangbuk-do (KR)

(21) Appl. No.: 19/479,614

(22) PCT Filed: Feb. 2, 2024
(86) PCT No.: PCT/KR2024/001587

§ 371 Date: Oct. 28, 2025

(30) Foreign Application Priority Data
Feb. 2, 2023 (KR) 10-2023-0014051
Jun. 14, 2023 (KR) 10-2023-0076109

(51) Int. Cl. B66F 9/06; B66F 9/075; G05D 1/228; G05D 1/667; G05D 105/28

(52) U.S. Cl. CPC B66F 9/063; B66F 9/0755; G05D 1/228; G05D 1/667; G05D 2105/28

(57) ABSTRACT

A bending-articulated unmanned robotic forklift includes a controller configured to control operation of a motor part on a basis of distance information and image information acquired through sensors and destination information input through an input/output part, so as to enable automatic and autonomous traveling to a destination while a mask part is bent.

### CROSS-REFERENCE TO PRIOR APPLICATIONS

This Application is a National Stage Patent Application of PCT International Application No. PCT/KR2024/001587 (filed on Feb. 2, 2024), which claims priority to Korean Patent Application Nos. 10-2023-0014051 (filed on Feb. 2, 2023) and 10-2023-0076109 (filed on Jun. 14, 2023), which are all hereby incorporated by reference in their entirety.

### BACKGROUND

The present invention relates to a bending-articulated unmanned robotic forklift system and an autonomous traveling method using the same, and more particularly, to a bending-articulated unmanned robotic forklift system, which can autonomously travel to a pallet in a lateral direction and bent traveling manner and then load and unload the pallet, and an autonomous traveling method using the same.

Generally, an unmanned forklift refers to a forklift that automatically transports cargo, and it is developed a lot as a transport means that replaces humans according to the 4th industrial revolution.

However, conventional unmanned forklifts have a problem in that they should secure a traveling radius greater than the length of the body when the forklift enters due to the structural characteristics of the forklifts.

Accordingly, an unmanned forklift having joints that bend left and right at a predetermined angle unlike the structure of conventional unmanned forklifts is proposed.

Meanwhile, there exists prior art related to unmanned forklifts that can accurately recognize their own position and orientation, thereby improving operational stability with respect to racks and pallets during loading and unloading operations.

However, even in such prior art, there is no disclosure regarding the securing of a turning radius.

### SUMMARY

Therefore, the present invention has been made in view of the above problems, and it is an object of the present invention to provide a bending-articulated unmanned robotic forklift system capable of minimizing the traveling radius when a forklift enters, and an autonomous traveling method using the same.

In addition, another object of the present invention is to provide a bending-articulated unmanned robotic forklift system capable of traveling from the current position to a destination while avoiding obstacles, and an autonomous traveling method using the same.

In addition, another object of the present invention is to provide a bending-articulated unmanned robotic forklift system capable of loading and unloading pallets, and an autonomous traveling method using the same.

The problems to be solved by the present invention are not limited to the problems mentioned above, and other problems to be solved by the present invention that are not mentioned herein will be clearly understood by those skilled in the art from the following description.

To accomplish the above objects, according to one aspect of the present invention, there is provided a bending-articulated unmanned robotic forklift system comprising: a main body part provided to travel along an inner space of a warehouse; a mast part provided to be connected to the main body part to settle a load; a joint part for connecting the main body part and the mast part to each other; a first sensor part provided at one side of the main body part; a second sensor part provided at one side of the mast part; an input/output part provided at one side of the main body part to allow a user to input and transmit destination information and a control mode by himself or herself; a motor part for providing driving power to the main body part, the mast part, and the joint part; and an integrated control part for controlling the motor part on the basis of signals from the first sensor part, the second sensor part, and the input/output part, wherein the integrated control part controls the operation of the motor part on the basis of distance information and image information acquired through the first sensor part and the second sensor part and the destination information input through the input/output part so that the unmanned forklift may automatically and autonomously travel to the destination while the mast part is bent.

In addition, after the main body part arrives at the destination, the integrated control part of the present invention automatically performs any one mode among a loading mode of loading a pallet, an unloading mode of unloading the pallet, and a standby mode of performing no operation by controlling the operation of the mast part based on the control mode input through the input/output part.

In addition, an autonomous traveling method of a bending-articulated unmanned robotic forklift system according to the present invention comprises: a position estimation step of estimating a current position of an unmanned forklift through a position recognition part; a work input step of inputting a destination and a control mode of the unmanned forklift through an input/output motor confirmation step of confirming abnormality of a driving module and a joint module through a motor part; an obstacle input step of inputting obstacle information through the input/output part; a path generation step of receiving the destination from the integrated control part, and generating a path of the unmanned forklift for travelling from a starting point to the destination; a forklift traveling step of controlling the unmanned forklift by the integrated control part to travel along the path; and a pallet control step of controlling the pallet by the integrated control part according to the control mode, after the unmanned forklift arrives at the destination.

In addition, at the work input step or the obstacle input step of the present invention, the destination of the unmanned forklift, the control mode, and the obstacle information may be input remotely through a remote client.

In addition, the path generation step of the present invention includes: a global path generation step of generating a global path connecting the current position of the unmanned forklift and the destination in a shortest distance through the integrated control part; and a local path generation step of generating a local path through the integrated control part to find the global path while avoiding obstacles based on the current position of the unmanned forklift.

As described above, according to the bending-articulated unmanned robotic forklift system of the present invention and the autonomous traveling method using the same, as a fork is formed to bend left and right, there is an effect of minimizing the traveling radius.

In addition, according to the bending-articulated unmanned robotic forklift system of the present invention and the autonomous traveling method using the same, as a path that avoids obstacles is generated, there is an effect in that the unmanned forklift may safely and efficiently travel to a destination.

In addition, according to the bending-articulated unmanned robotic forklift system of the present invention and the autonomous traveling method using the same, there is an effect in that the unmanned forklift may load or unload pallets using a camera and a sensor.

The effects of the present invention are not limited to the effects mentioned above, and unmentioned other effects will be clearly understood by those skilled in the art from the detailed description and the description of the claims.

### BRIEF DESCRIPTION OF THE DRAWINGS

FIG. 1 is an exemplary view showing a bending-articulated unmanned robotic forklift system according to the present invention.

FIG. 2 is a control flowchart showing a bending-articulated unmanned robotic forklift system according to the present invention.

FIG. 3 is a view showing the detailed configuration of the control part of a bending-articulated unmanned robotic forklift system according to the present invention.

FIG. 4 is a flowchart schematically illustrating an autonomous traveling method of a bending-articulated unmanned robotic forklift system according to the present invention.

FIG. 5 is a flowchart specifically illustrating the obstacle setting step of an autonomous traveling method of a bending-articulated unmanned robotic forklift system according to the present invention.

FIG. 6 is a flowchart illustrating the detailed steps of a path generation step of an autonomous traveling method of a bending-articulated unmanned robotic forklift system according to the present invention.

FIG. 7 is a flowchart specifically illustrating the local path generation step of an autonomous traveling method of a bending-articulated unmanned robotic forklift system according to the present invention.

FIG. 8 is a flowchart specifically illustrating the forklift traveling step of an autonomous traveling method of a bending-articulated unmanned robotic forklift system according to the present invention.

FIG. 9 is a flowchart specifically illustrating the pallet control step of an autonomous traveling method of a bending-articulated unmanned robotic forklift system according to the present invention.

FIG. 10 is a flowchart specifically illustrating the loading mode of the pallet control step of an autonomous traveling method of a bending-articulated unmanned robotic forklift system according to the present invention.

FIG. 11 is a flowchart specifically illustrating the unloading mode of the pallet control step of an autonomous traveling method of a bending-articulated unmanned robotic forklift system according to the present invention.

FIG. 12 is a view showing an example of the operation of a bending-articulated unmanned robotic forklift system according to the present invention.

FIG. 13 is a view schematically showing the use of a second camera and a third camera of a second sensor part in the pallet control step of an autonomous traveling method of a bending-articulated unmanned robotic forklift system according to the present invention.

### DETAILED DESCRIPTION

The terms used in this specification will be described briefly, and the present invention will be described in detail.

Although the terms used in the present invention are selected from the currently and widely used terms as much as possible, considering their functions in the present invention, these terms may vary according to the intentions of those skilled in the art, precedents, emergence of new technologies, and the like. Accordingly, the terms used in the present invention should be defined based on the meaning of the terms and the overall contents of the invention, rather than simply based on the names of the terms.

When a part is said to “include” a component throughout the specification, this means that it may further include other components, rather than excluding other components, unless stated otherwise.

Hereinafter, embodiments of the present invention will be described in detail so that those skilled in the art may easily implement them with reference to the accompanying drawings. However, the present invention may be implemented in various different forms and is not limited to the embodiments described herein.

Specific matters including the problems to be solved in the present invention, means of solving the problems, and the effects the invention are included in the embodiments and drawings described below. The advantages and features of the present invention and the methods for achieving them will become clear with reference to the embodiments described below in detail, together with the accompanying drawings.

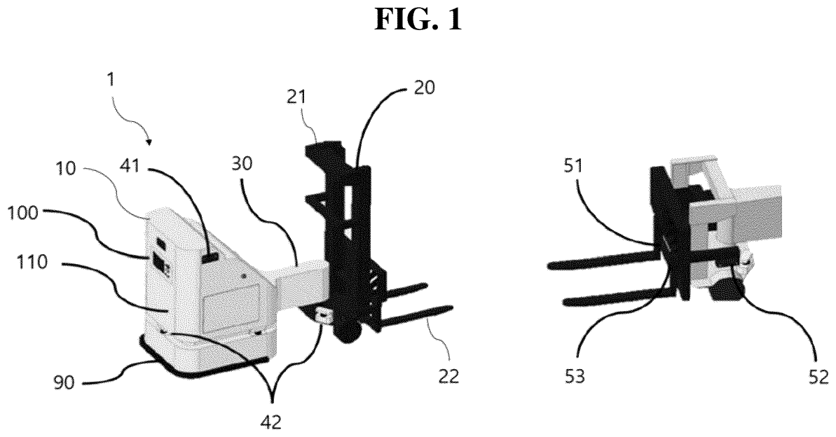

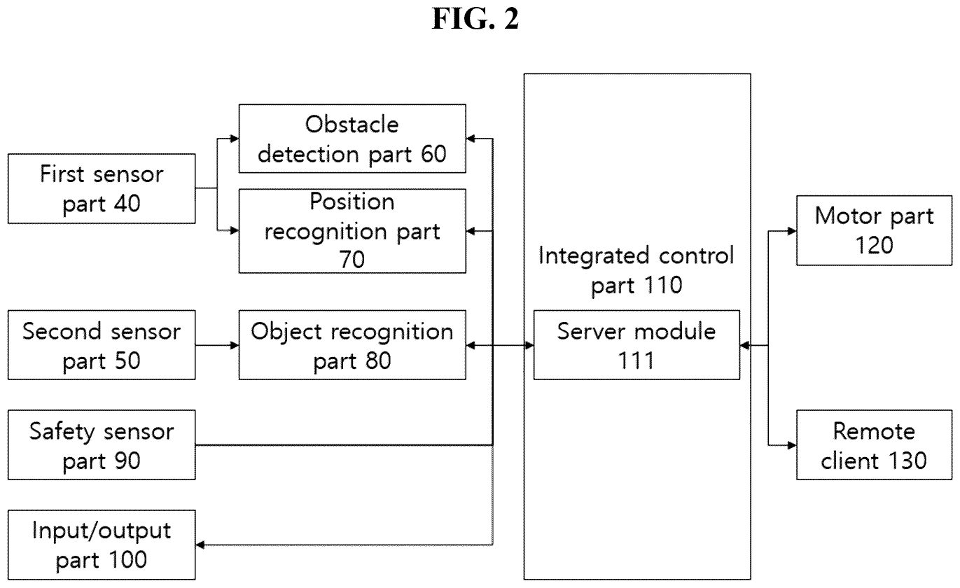

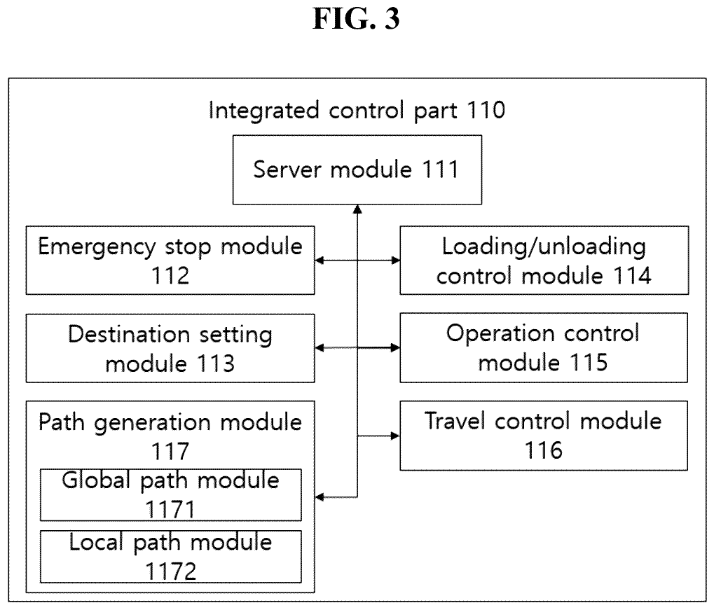

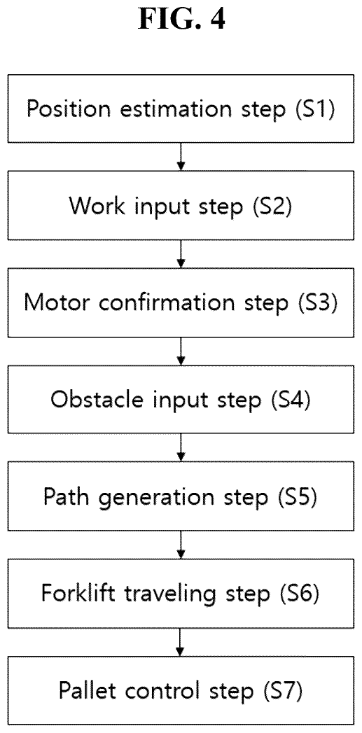

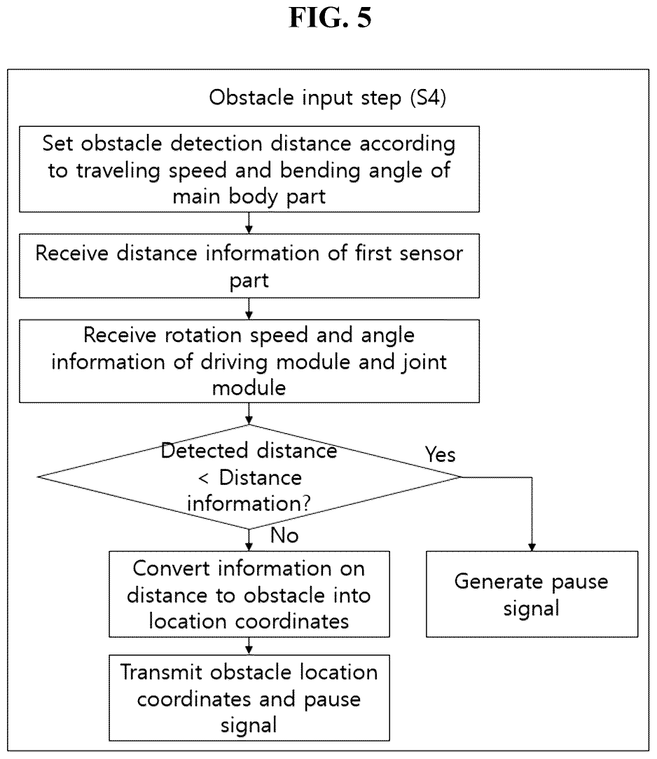

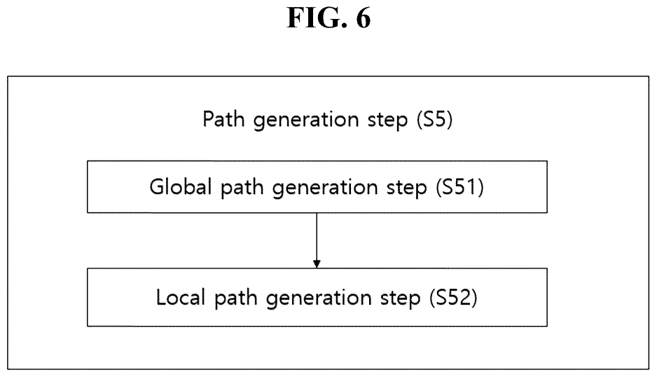

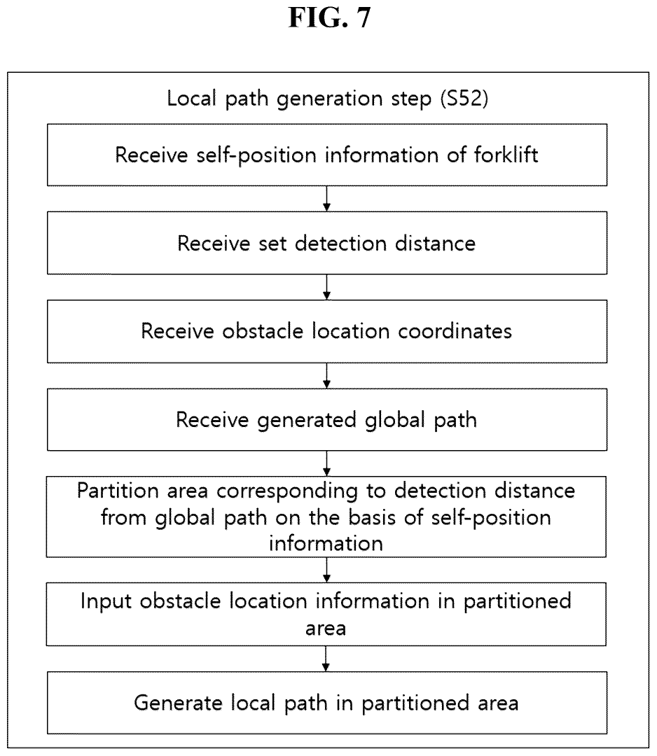

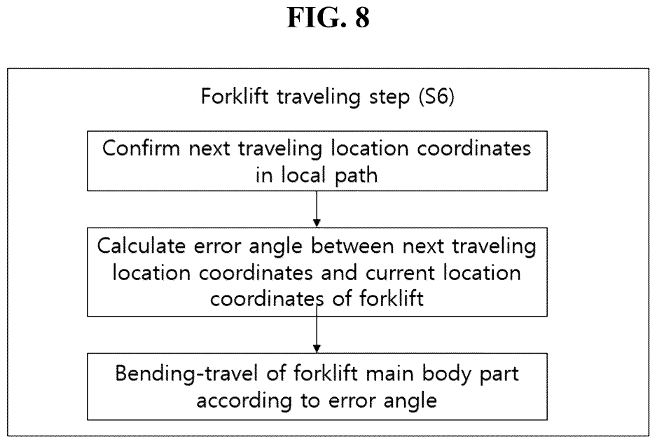

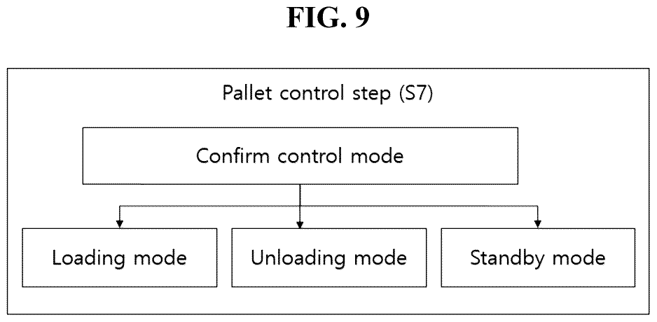

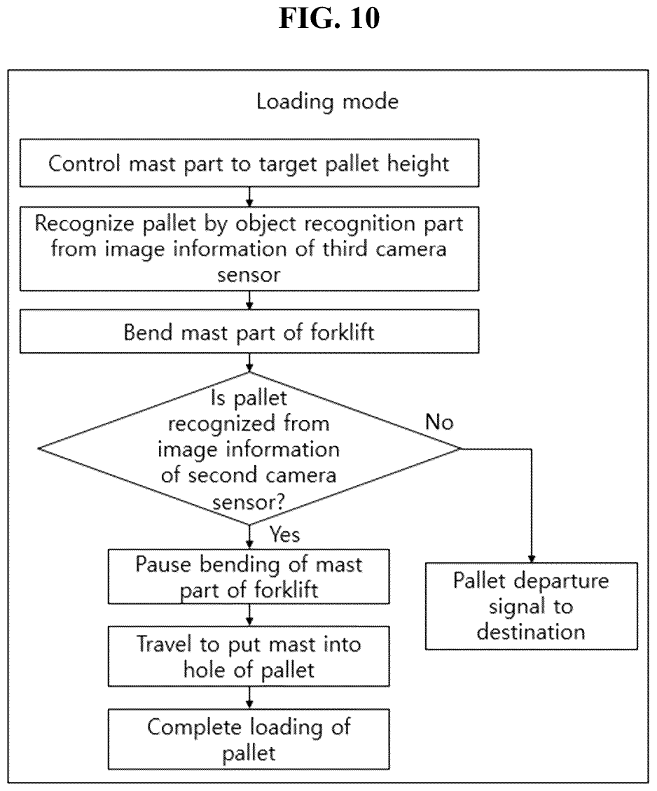

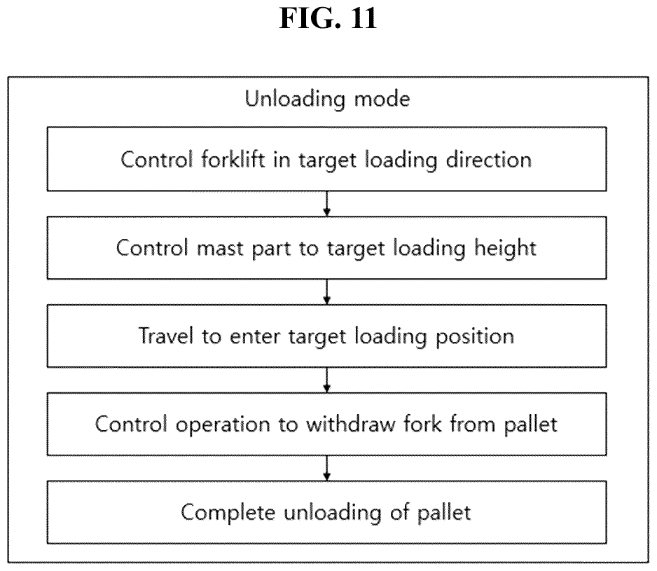

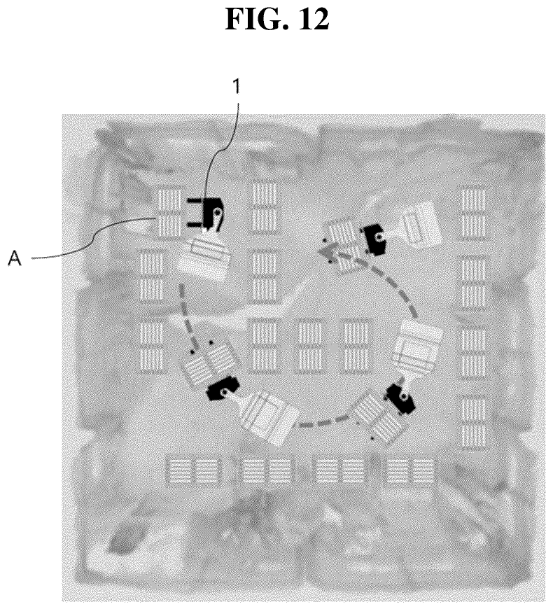

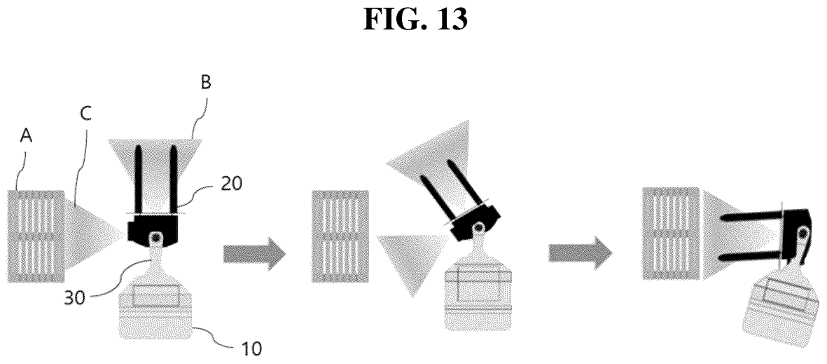

FIG. 1 is an exemplary view showing a bending-articulated unmanned robotic forklift system according to the present invention, FIG. 2 is a control flowchart showing a bending-articulated unmanned robotic forklift system according to the present invention, FIG. 3 is a view showing the detailed configuration of the control part of a bending-articulated unmanned robotic forklift system according to the present invention, FIG. 4 is a flowchart schematically illustrating an autonomous traveling method of a bending-articulated unmanned robotic forklift system according to the present invention, flowchart specifically FIG. 5 is a illustrating the obstacle setting step of an autonomous traveling method of a bending-articulated unmanned robotic forklift system according to the present invention, FIG. 6 is a flowchart illustrating the detailed steps of a path generation step of an autonomous traveling method of a bending-articulated unmanned robotic forklift system according to the present invention, FIG. 7 is a flowchart specifically illustrating the local path generation step of an autonomous traveling method of a bending-articulated unmanned robotic forklift system according to the present invention, FIG. 8 is a flowchart specifically illustrating the forklift traveling step of an autonomous traveling method of a bending-articulated unmanned robotic forklift system according to the present invention, FIG. 9 is a flowchart specifically illustrating the pallet control step of an autonomous traveling method of a bending-articulated unmanned robotic forklift system according to the present invention, FIG. 10 is a flowchart specifically illustrating the loading mode of the pallet control step of an autonomous traveling method of a bending-articulated unmanned robotic forklift system according to the present invention, FIG. 11 is a flowchart specifically illustrating the unloading mode of the pallet control step of an autonomous traveling method of a bending-articulated unmanned robotic forklift system according to the present invention, FIG. 12 is a view showing an example of the operation of a bending-articulated unmanned robotic forklift system according to the present invention, and FIG. 13 is a view schematically showing the use of a second camera and a third camera of a second sensor part in the pallet control step of an autonomous traveling method of a bending-articulated unmanned robotic forklift system according to the present invention.

Hereinafter, an autonomous traveling method of a bending-articulated unmanned robotic forklift system according to the present invention will be described in detail with reference to the accompanying drawings.

The object of the autonomous traveling method of a bending-articulated unmanned robotic forklift system according to the present invention is to provide an autonomous traveling method of a bending-articulated unmanned robotic forklift system capable of autonomously traveling to a pallet in a lateral direction and bent traveling manner and then loading and unloading the pallet.

Referring to FIGS. 1 and 2, the bending-articulated unmanned robotic forklift system includes a main body part 10, a mast part 20, a joint part 30, a first sensor part 40, a second sensor part 50, an input/output part 100, a motor part 120, and an integrated control part 110.

First, the main body part 10 is provided. The main body part 10 is configured as the main body of an autonomous traveling method of the bending-articulated unmanned robotic forklift system, and may be formed in a structure similar to that of a general forklift. The main body part 10 may be provided to travel along the inner space of a warehouse. In addition, the main body part 10 may include a plurality of wheels at one side, and may transmit power to the wheels.

Next, the mast part 20 is provided. The mast part 20 is connected to the front side of the main body part 10, and is provided to settle a load thereon.

In addition, the mast part 20 may be rotatably coupled to the main body part 10 in one direction. Accordingly, when the main body part 10 travels, the mast part 20 avoids the load, and the traveling radius of the main body part 10 can be minimized.

In addition, the mast part 20 may include a mast 21 and a fork 22.

The mast 21 may be provided in a form in which a plurality of supports is erected vertically, and may move the fork 22 up and down. The mast 21 may include a cylinder that generates power to allow the fork 22 to reciprocate.

The fork 22 is connected to the mast 21 at one side and may support the lower part of the load. Of course, the fork 22 may be provided in plural.

Next, the joint part 30 is provided. The joint part 30 is a configuration connecting the main body part 10 and the mast part 20 to each other.

Next, the first sensor part 40 is provided. The first sensor is provided at one side of the main body part 10. More specifically, the first sensor includes a LiDAR sensor 41 and a first camera sensor 42.

The LiDAR sensor 41 is provided to measure the distance in the surrounding environment. The LiDAR sensor 41 may calculate the distance by emitting a laser beam and measuring the time of the beam reflected and returned from an object. That is, the LiDAR sensor 41 may accurately determine the position and distance of objects in the surrounding environment by scanning a three-dimensional space.

In addition, the first camera sensor 42 is provided to detect the surrounding environment. The first camera sensor 42 may generate images using light. That is, the first camera sensor may accurately detect the surrounding environment by photographing surrounding spaces. In addition, the first camera sensor 42 may include an IMU sensor to estimate movements of objects.

Next, the second sensor part 50 is provided. The second sensor is provided at one side of the mast part 20. More specifically, the second sensor includes a second camera sensor 51, a third camera sensor 52, and a settlement detection sensor 53.

Since the second camera sensor 51 and the third camera sensor 52 are the sane as the first camera sensor, description of the first camera sensor 42 is used instead. In addition, the settlement detection sensor 53 is provided to detect whether a load is settled on the fork.

Next, the input/output part 100 is provided. The input/output part 100 is provided at one side of the main body part 10, and a user himself or herself inputs destination information and a control mode to transmit. More specifically, the input/output part 100 includes a display module 101 and an input/output switch module 102.

The display module 101 is provided to output the destination information and the control mode input by the user. Of course, the display module 101 may output all information other than the destination information and the control mode. In addition, the input/output switch module 102 is provided to allow a user to input by himself or herself. In other words, the user may input the destination information and the control mode through the input/output switch module 102.

Next, the motor part 120 is provided. The motor part may supply driving power to the main body part 10, the mast part 20, and the joint part. In other words, the motor part 120 may generate driving power to rotate the main body part 10, the mast part 20, and the front wheel drive part 230. Accordingly, the fork 22 may rotate in one direction. More specifically, the motor part 120 may include a mast module 121, a driving module 122, and a joint module 123.

The mast module 121 may include a motor that vertically controls the mast 21 up and down, a numerical sensor that confirms the absolute value of height, a tilting motor that may tilt forward and backward, and a tilt sensor that measures the tilt angle.

In addition, the mast module 121 is provided at one side of the mast part 20 to provide a driving power capable of operating the mast part 20. In addition, the driving module 122 is provided at one side of the main body part 10 to provide a driving power capable of operating the main body part 10. In addition, the joint module 123 is provided at one side of the joint part to provide a driving power capable of operating the joint part.

The driving module 122 is provided as a motor that provides a driving power so that the unmanned forklift 1 may drive to move, and the joint module 123 is configured of a rotation motor that may allow the joint part 30 to assist control of the transition of the mast part 20 in the left-right direction, and an angle sensor that measures the angle of the rotation motor.

Next, the integrated control part 110 is provided. The integrated control part 110 controls the motor part 120 based on the signals of the first sensor part 40, the second sensor part 50, and the input/output part 100. More specifically, referring to FIG. 3, the integrated control part 110 includes a server module 111, an emergency stop module 112, a destination setting module 113, a loading/unloading control module 114, an operation control module 115, a travel control module 116, and a path generation module 117, and the path generation module 117 includes a global path module 1171 and a local path module 1172.

The server module 111 is provided to be connected to the unmanned forklift 1 from the outside to remotely control the unmanned forklift 1. Describing easily, the server module 111 allows the integrated control part 110 and a remote client 130 described below to be connected to each other.

In addition, the emergency stop module 112 is a module that controls the motor part 120 so that the unmanned forklift 1 may make an emergency stop. The emergency stop module 112 may transmit detected data of the safety sensor part 90 and location information of the obstacle detection part to the integrated control part 110. The destination setting module 113 is a module for setting the destination of the unmanned forklift 1, the loading/unloading control module 114 is a module for controlling the motor part 120 so that the unmanned forklift 1 may perform an operation of loading and unloading pallets A, the operation control module 115 is a module for controlling the motor part 120 so that the operation of the unmanned forklift 1 may be controlled, the travel control module 116 is a module for controlling the motor part 120 so that the unmanned forklift 1 may travel autonomously, and the path generation module 117 is a module for setting the path of the unmanned forklift 1.

The server module 111, the emergency stop module 112, the destination setting module 113, the loading/unloading control module 114, the operation control module 115, the travel control module 116, and the path generation module 117 are interconnected, and may organically cooperate to control the unmanned forklift 1.

The integrated control part 110 controls the operation of the joint part and the motor part 120 based on the distance information and image information acquired through the first sensor part 40 and the second sensor part 50 and the destination information input through the input/output part 100, so that the unmanned forklift may automatically and autonomously travel to the destination while the mast part 20 is bent.

In other words, the integrated control part 110 may bend the mast part 20 to allow the unmanned forklift 1 to automatically travel to the destination while avoiding obstacles.

In addition, after the main body part 10 arrives at the destination, the integrated control part 110 may automatically perform any one mode among a loading mode of loading a pallet A, an unloading mode of unloading the pallet A, and a standby mode of performing no operation by controlling the operation of the mast part 20 based on the control mode input through the input/output part 100.

In other words, after the unmanned forklift 1 arrives at the destination, the integrated control part 110 automatically performs any one of the control modes input by the user.

In summary, through the integrated control part 110, the unmanned forklift 1 may automatically travel to the destination input by the user while avoiding the obstacles, and when the unmanned forklift 1 arrives at the destination, it may perform subsequent tasks according to the control mode input by the user.

In addition, the bending-articulated unmanned robotic forklift system according to the present invention further includes a position recognition part 70, an obstacle detection part 60, an object recognition part 80, and a safety sensor part 90.

The position recognition part 70 may generate a map and calculate the current position of the unmanned forklift 1 using the image information and distance information acquired from the first sensor part 40. At this point, the generated map may include two-dimensional coordinate information and three-dimensional coordinate information. More specifically, the position recognition part 70 includes an artificial intelligence module 71 and an object location calculation module 72.

The obstacle detection part 60 may detect the location of obstacles around the unmanned forklift 1 by combining the distance information and the map. More specifically, the obstacle detection part 60 includes a map generation module 61 and a self-position calculation module 62.

The object recognition part 80 may recognize a pallet A and object information from the image information acquired from the second camera sensor 51 and the third camera sensor 52 using artificial intelligence, and calculate location coordinates.

The safety sensor part 90 is provided as a sensor that allows the unmanned forklift 1 to make an emergency stop. More specifically, the safety sensor part 90 includes an emergency stop switch 91 and a bumper sensor 92.

Hereinafter, the autonomous traveling method of a bending-articulated unmanned robotic forklift system according to the present invention will be described in detail with reference to the accompanying drawings. The autonomous traveling method of a bending-articulated unmanned robotic forklift system is performed using the bending-articulated unmanned robotic forklift system.

Referring to FIG. 4, the autonomous traveling method of a bending-articulated unmanned robotic forklift system includes a position estimation step (S1) of estimating the current position of the unmanned forklift through the position recognition part 70, a work input step (S2) of inputting a destination and a control mode of the unmanned forklift 1 through the input/output part 100, a motor confirmation step (S3) of confirming abnormality of the driving module 122 and the joint module 123 through the motor part 120, an obstacle input step (S4) of inputting obstacle information through the input/output part 100, a path generation step (S5) of receiving the destination from the integrated control part 110, and generating a path of the unmanned forklift 1 for travelling from a starting point to the destination, a forklift traveling step (S6) of controlling the unmanned forklift 1 by the integrated control part 110 to travel along the path, and a pallet control step (S7) of controlling the pallet A by the integrated control part 110 according to the control mode, after the unmanned forklift 1 arrives at the destination.

First, the position estimation step (S1) is a process of estimating the current position of the unmanned forklift through the position recognition part 70. More specifically, the position recognition part 70 receives the distance information and the image information from the LiDAR sensor 41 and the first camera sensor 42 of the first sensor part 40, respectively. Then, the position recognition part 70 may generate a map based on the distance information and the image information, and estimate the current position of the unmanned forklift 1 based on the map. Then, the position recognition part 70 may transmit the generated map and the current position of the unmanned forklift 1 to the integrated control part 110. The integrated control part 110 may set a direction based on the current position so that the direction that the mast part 20 of the unmanned forklift 1 faces is the forward direction.

Next, the work input step (S2) is a process of inputting a destination and a control mode of the unmanned forklift 1 through the input/output part 100. More specifically, the user may input a destination, to which the unmanned forklift 1 is to move, and the control mode through the input/output part 100. At this point, when any one among the loading mode and the unloading mode of the control mode is input, the loading and unloading height of the pallet may also be input. The input/output part 100 may transmit the information input by the user to the destination setting module 113 of the integrated control part 110. In addition, the destination setting module 113 may collect the input information.

Next, the motor confirmation step (S3) is a process of confirming abnormality of the driving module 122 and the joint module 123 through the motor part 120. More specifically, the motor part 120 may confirm the current state of the driving module 122 and the joint module 123. At this point, the current state may include power of the motor, the driving direction of the motor, and the current angle and speed of the motor. Of course, the motor part 120 may transmit the current state to the integrated control part 110.

Next, the obstacle input step (S4) is a process of inputting obstacle information through the input/output part 100. More specifically, the user may set an obstacle detection distance in the obstacle detection part 60 through the input/output part 100. In addition, the obstacle detection part 60 may transmit the obstacle location coordinates and a pause signal to the integrated control part 110.

More specifically, referring to FIG. 5, the obstacle location coordinates and flow of the pause signal are shown. The user may set the obstacle detection distance with respect to the speed of the unmanned forklift 1 and the bending angle of the mast part 20 through the input/output part 100. In addition, the first sensor part 40 acquires and transmits the distance information to the obstacle detection part 60. The integrated control part 110 transmits rotation speed of the motor and information on the angle between the driving module 122 and the joint module 123 acquired in real time to the obstacle detection part 60 to confirm the speed of the unmanned forklift 1 and the bending rate of the mast part 20.

The integrated control part 110 may compare the distance information acquired from the first sensor part 40 with the detection distance input by the user. At this point, when the distance information acquired from the first sensor part 40 is larger than the detection distance, the integrated control part 110 generates a pause signal for pausing the unmanned forklift 1 and transmits the pause signal to the integrated control part 110. In addition, when the distance information acquired from the first sensor part 40 is smaller than the detection distance, the obstacle detection part 60 converts the distance information of the first sensor part 40 into location coordinates and transmits the location coordinates to the integrated control part 110.

In addition, as the speed increases, the detection distance and range of the obstacle increase, and as the speed decreases, the detection distance and range of the obstacle decrease. In addition, the detection distance and range in the direction of bending the mast part 20 decreases according to the bending angle, and the detection distance and range in the opposite direction of bending the mast part 20 increase.

In addition, at the work input step (S2) or the obstacle input step (S4), the destination of the unmanned forklift 1, the control mode, and the obstacle information may be input remotely through the remote client 130. Describing easily, at the work input step (S2), a user may input the destination of the unmanned forklift 1 to move and the control mode in a remote access method using the remote client 130. In addition, at the obstacle input step (S4), the user may set an obstacle detection distance with respect to the speed of the unmanned forklift 1 and the bending angle of the mast part 20 in a remote access method using the remote client 130.

Next, the path generation step (S5) is a process of receiving the destination from the integrated control part 110, and generating a path of the unmanned forklift 1 for travelling from the starting point to the destination. More specifically, referring to FIG. 6, the path generation step (S5) includes a global path generation step (S51) of generating a global path connecting the current position of the unmanned forklift 1 and the destination in the shortest distance through the integrated control part 110, and a local path generation step (S52) of generating a local path through the integrated control part 110 to find the global path while avoiding obstacles based on the current position of the unmanned forklift 1.

In addition, the procedure of the local path generation step (S52) is illustrated in FIG. 7. The local path module 1172 of the integrated control part 110 sequentially receives the location information from the position recognition part 70, the obstacle detection distance input by the user through the input/output part 100 and the remote client 130, the obstacle location coordinates of the obstacle detection part 60, and the global path. The local path module 1172 may set a local area on the global path by partitioning an area corresponding to the detection distance set based on the location information. Then, the local path module 1172 inputs the obstacle location coordinates onto the partitioned local area. In addition, the local path module 1172 may generate a local path that avoids the obstacle location at the current position in the local area and connects to the global path.

Next, the forklift traveling step (S6) is a process of controlling the unmanned forklift 1 by the integrated control part 110 to travel along the path. More specifically, the procedure of the forklift traveling step (S6) is illustrated in FIG. 8. That is, the procedure of controlling the unmanned forklift 1 to travel along the local path is illustrated. The integrated control part 110 sets a coordinate point perpendicular to the direction of the unmanned forklift 1 traveling on the local path as the next traveling location coordinates. At this point, when the perpendicular coordinate point is not confirmed, the integrated control part 110 may set the coordinate point to the closest coordinates on the local path among the location coordinates of the unmanned forklift 1.

In addition, the integrated control part 110 may calculate an error angle between the next traveling location coordinates and the location coordinates of the unmanned forklift 1 to confirm whether a bending state is necessary during traveling of the unmanned forklift 1. At this point, the error angle may be calculated as shown the following [Equation 1].

$$error angle = a tan \frac{( y coordinate error )}{( x coordinate error )} \qquad [ Equation 1 ]$$

At this point, the y coordinate error is y1-y2, the x coordinate error is x1-x2, x1 and y1 may be the next traveling location coordinates on the generated path, and x2 and y2 may be the current location coordinates of the unmanned forklift 1.

In addition, when the error angle is positive, the unmanned forklift 1 travels while bending to the right, and when the error angle is negative, the unmanned forklift 1 travels while bending to the left.

Finally, the pallet control step (S7) is a process of controlling the pallet A by the integrated control part 110 according to the control mode after the unmanned forklift 1 arrives at the destination. More specifically, referring to FIG. 9, after the main body part 10 arrives at the destination, the integrated control part 110 confirms the control mode input through the input/output part 100. Then, the integrated control part 110 may control the pallet A according to the control mode. At this point, the control mode controls the operation of the mast part 20 based on the control mode input through the input/output part, and includes a loading mode for loading the pallet A, an unloading mode for unloading the pallet A, and a standby mode for performing no operation, and any one of the modes can be performed automatically.

In addition, referring to FIG. 10, the procedure according to the loading mode is illustrated. The integrated control part 110 controls up-and-down movement of the mast part 20 according to the height of the pallet A. Then, when the pallet A reaches a target height, image information acquired from the third camera sensor 52 of the second sensor part 50 is transmitted to the object recognition part 80. The object recognition part 80 may find and recognize the pallet A using artificial intelligence technology. At this point, the artificial intelligence technology may be, for example, technology such as Yolov5. In addition, when the object recognition part 80 recognizes the pallet A from the image information of the third camera sensor 52, the operation control module 115 of the integrated control part 110 may bend the mast part 20 in the left-and-right direction in which the main body part 10 of the unmanned forklift 1 recognizes the pallet A. In addition, when the object recognition part 80 recognizes the pallet A from the image information of the second camera sensor 51, the operation control module 115 of the integrated control part 110 may stop bending of the mast part 20. At this point, when the object recognition part 80 does not recognize the pallet A from the image information of the second camera sensor 51, it transmits a pallet A departure signal to the integrated control part 110.

The object recognition part 80 may estimate the position of the pallet A recognized from the image information of the second camera sensor 51. In addition, the travel control module 116 of the integrated control part 110 controls traveling of the main body part 10 so that the forklift 22 of the unmanned forklift 1 may enter the hole of the pallet A. At this point, when the settlement detection sensor 53 detects settlement of the pallet A while the forklift 22 enters the pallet A, the travel control module 116 may stop traveling of the main body part 10. Thereafter, the integrated control part 110 may complete loading of the pallet A by controlling the operation of the mast module 121 to adjust the height of the mast part 20 so that the pallet A may be safely settled on the forklift 22.

In addition, referring to FIG. 11, the procedure according to the unloading mode is illustrated. The operation control module 115 of the integrated control part 110 may control the operation of the mast part 20 so that the mast part 20 may face the target unloading direction. In addition, the operation control module 115 may control the operation of the mast module 121 so that the mast part 20 reaches the unloading target height.

When the mast part 20 reaches the unloading target height, the travel control module 116 controls traveling of the main body part 10 so that the forklift 22 may enter the target loading position.

When the unmanned forklift 1 has entered the position for unloading the pallet A, the operation control module 115 controls the operation of the main body part 10 to withdraw the forklift 22. At this point, the object recognition part 80 receives the image information and the distance information acquired from the second camera sensor 51 and transmits a signal to the operation control module 115 until the forklift 22 is completely withdrawn.

When the forklift 22 is completely withdrawn and the object recognition part 80 does not transmit a signal to the operation control module 115 anymore, the operation of unloading the pallet A is completed. At this point, the three-dimensional coordinate information on the unloading position of the pallet A is stored in the destination setting and the storage module.

As described above, those skilled in the art may understand that the configuration of the present invention described above can be implemented in other specific forms without changing the technical spirit or essential features of the present invention.

Therefore, the embodiments described above should be understood as being exemplary and not restrictive in all respects, and the scope of the present invention is indicated by the claims described below rather than the detailed description, and all changes or modified forms derived from the meaning and scope of the claims and their equivalent concepts should be interpreted as being included in the scope of the present invention.

### DESCRIPTION OF SYMBOLS

1: Unmanned forklift
A: Pallet
B: Second camera sensor detection range
C: Third camera sensor detection range
10: Main body part
20: Mast part
21: Mast
22: Forklift
30: Joint part
40: First sensor part
41: LiDAR sensor
42: First camera sensor
50: Second sensor part
51: Second camera sensor
52: Third camera sensor
53: Settlement detection sensor
60: Obstacle detection part
61: Map generation module
62: Self-position calculation module
70: Position recognition part
71: Artificial intelligence module
72: Object location calculation module
80: Object recognition part
90: Safety sensor part
91: Emergency stop switch
92: Bumper sensor
100: Input/Output part
101: Display module
102: Input/Output switch module
110: Integrated control part
111: Server module
112: Emergency stop module
113: Destination setting module
114: Loading/Unloading control module
115: Operation control module
116: Travel control module
117: Path generation module
1171: Global path module
1172: Local path module
120: Motor part
121: Mast module
122: Drive module
123: Joint module
130: Remote client
S1: Position estimation step
S2: Work input step
S3: Motor confirmation step
S4: Obstacle input step
S5: Path generation step
S51: Global path generation step
S52: Local path generation step
S6: Forklift traveling step
S7: Pallet control step

1. A bending-articulated unmanned robotic forklift system comprising:
a main body part provided to travel along an inner space of a warehouse;
a mast part provided to be connected to the main body part to settle a load;
a joint part for connecting the main body part and the mast part to each other;
a first sensor part provided at one side of the main body part;
a second sensor part provided at one side of the mast part;
an input/output part provided at one side of the main body part to allow a user to input and transmit destination information and a control mode by himself or herself;
a motor part for providing driving power to the main body part, the mast part, and the joint part; and
an integrated control part for controlling the motor part on the basis of signals from the first sensor part, the second sensor part, and the input/output part, wherein
the integrated control part controls the operation of the motor part on the basis of distance information and image information acquired through the first sensor part and the second sensor part and the destination information input through the input/output part so that the unmanned forklift may automatically and autonomously travel to the destination while the mast part is bent.

2. The system according to claim 1, wherein after the main body part arrives at the destination, the integrated control part automatically performs any one mode among a loading mode of loading a pallet, an unloading mode of unloading the pallet, and a standby mode of performing no operation by controlling the operation of the mast part based on the control mode input through the input/output part.

3. An autonomous traveling method of a bending-articulated unmanned robotic forklift system, the method comprising:
a position estimation step of estimating a current position of an unmanned forklift through a position recognition part;
a work input step of inputting a destination and a control mode of the unmanned forklift through an input/output part;
a motor confirmation step of confirming abnormality of a driving module and a joint module through a motor part;
an obstacle input step of inputting obstacle information through the input/output part;
a path generation step of receiving the destination from the integrated control part, and generating a path of the unmanned forklift for travelling from a starting point to the destination;
a forklift traveling step of controlling the unmanned forklift by the integrated control part to travel along the path; and
a pallet control step of controlling the pallet by the integrated control part according to the control mode, after the unmanned forklift arrives at the destination.

4. The method according to claim 3, wherein at the work input step or the obstacle input step, the destination of the unmanned forklift, the control mode, and the obstacle information may be input remotely through a remote client.

5. The method according to claim 3, wherein the path generation step includes:
a global path generation step of generating a global path connecting the current position of the unmanned forklift and the destination in a shortest distance through the integrated control part; and
a local path generation step of generating a local path through the integrated control part to find the global path while avoiding obstacles based on the current position of the unmanned forklift.
